(19) United States
(12) Patent Application Publication
(10) Pub. No.: US 2013/0049837 A1
(43) Pub. Date: Feb. 28, 2013

(54) SYSTEM-ON-A-CHIP INTEGRATED CIRCUIT HAVING TIME CODE RECEIVER CLOCK SOURCE AND METHOD OF OPERATION THEREOF

(71) Applicants: Oren Eliezer, Plano, TX (US); Tom Jung, Dallas, TX (US)

(72) Inventors: Oren Eliezer, Plano, TX (US); Tom Jung, Dallas, TX (US)

(21) Appl. No.: 13/297,754

(22) Filed: Nov. 16, 2011

Related U.S. Application Data
(60) Provisional application No. 61/527,967, filed on Aug. 26, 2011.

(51) Int. Cl. G06F 1/04

(52) U.S. Cl. 327/291

(57) ABSTRACT

A system-on-a-chip (SoC), a method of serving a Stratum-1 clock signal from an SoC and a device including the SoC. In one embodiment, the SoC includes: (1) a monolithic substrate, (2) a time code receiver clock source supported by the monolithic substrate and configured to receive a timing signal and generate a clock signal for the SoC and (3) at least one of a processor, memory and other SoC circuitry supported by the monolithic substrate and configured to receive the clock signal from the time code receiver clock source.

### CROSS-REFERENCE TO RELATED APPLICATION

This application claims the benefit of U.S. Provisional Application Ser. No. 61/527,967, filed by Eliezer, et al., on Aug. 26, 2011, entitled “Time Code Receiver Integrated in a System-on-a-Chip Integrated Circuit,” commonly assigned with this application and incorporated herein by reference. This application is also related to PCT Patent Application Serial No. PCT/US11/52770, filed by Eliezer, et al., on Sep. 22, 2011, entitled “Low Power Radio Controlled Clock Incorporating Independent Timing Corrections,” and U.S. Ser. No. 13/240,615, filed by Eliezer, et al., on Sep. 22, 2011, entitled “Low Power Radio Controlled Clock Incorporating Independent Timing Corrections,” and U.S. patent application Ser. No. 13/291,708, filed by Eliezer, et al., on Nov. 8, 2011, entitled “Mixed Signal Integrator Incorporating Extended Integration Duration,” both commonly assigned with this application and incorporated herein by reference.

### TECHNICAL FIELD

This application is directed, in general, to a system-on-a-chip (SoC) integrated circuits (ICs) and, more specifically, to an SoC IC having an on-chip time code receiver clock source and a method of serving a clock signal from an SoC.

### BACKGROUND

System-on-a-chip (SoC) integrated circuits are complex devices incorporating many functions onto a single (e.g., silicon) substrate, also known as a “chip” or “die.” They often contain both digital and analog circuits and may include radio-frequency (RF) circuits as well. SoCs enable the design of products that are smaller, cost less and consume less power than those based on more than one die.

Time and frequency requirements for SoCs vary depending on the application. Most SoCs have a need for “non-precise” time and frequency knowledge, such as that a ±20 ppm crystal or other local oscillator is able to supply. However, some require more accurate references to generate precise timing pulses, waveforms and schedules.

Many industrial applications require a precise time reference, frequency reference, or both, to operate properly. Telecommunications networks, cellular phone networks and power grids are some examples. As confirmed in Lombardi, “Comparing LORAN Timing Capability to Industrial Requirements,” 35^{th} Annual ILA Conference, Groton, Conn. October 2006, http://tf.nist.gov/general/pdf/2193.pdf, current industrial requirements are ±1 μs for time accuracy and ±1×10⁻¹¹ for frequency accuracy to Coordinated Universal time (UTC). These requirements are met by time code receiver clock sources, the most common of which uses a Global Positioning Satellite (GPS)-disciplined oscillator.

A GPS-disciplined oscillator contains a local oscillator that does not meet the accuracy requirements. However, a GPS receiver associated with the local oscillator periodically receives a radio signal from one of a constellation of GPS satellites and uses it to adjust the local oscillator's time and frequency output. The GPS signal can provide a time accuracy of ±0.1 μs and a frequency accuracy of ±1×10⁻¹³ (see, e.g., Lombardi, et al., “The Potential Role of Enhanced LORAN-C in the National Time and Frequency Infrastructure,” 34^{th} Annual ILA Conference, Santa Barbara, Calif., October, 2005, http://tf.nist.gov/general/pdf/2105.pdf).

Enhanced Long-Range Navigation (LORAN)-disciplined oscillators are being explored as an alternative to GPS, but while being capable of meeting the Stratum-1 frequency requirement, are not capable of meeting the time requirement. However, eLORAN receivers would have to be designed and relatively widely deployed for eLORAN to become a recognized standard. Such does not appear likely at the present time.

The National Institute of Standards and Technology (NIST) also broadcasts an amplitude modulated timing signal on a low frequency radio station having the call letters “WWVB.” Because NIST employs a Cesium-based atomic clock to drive its timing signal, the NIST timing signal is colloquially referred to as an “atomic clock.” It is accordingly very accurate, having a frequency accuracy of ±5×10⁻¹² (supra). However, because the signal is amplitude modulated and broadcast at 60 kHz, it is limited to a received time accuracy of ±100 μs. Ironically, while NIST's WWVB atomic clock timing signal meets the Stratum-1 frequency requirement, it does not meet the time accuracy requirement.

### SUMMARY

One aspect provides an SoC. In one embodiment, the SoC includes: (1) a monolithic substrate, (2) a time code receiver supported by the monolithic substrate and configured to receive a timing signal and generate a clock signal for the SoC and (3) at least one of a processor, memory and other SoC circuitry supported by the monolithic substrate and configured to receive the clock signal from the time code receiver clock source.

Another aspect provides a method of serving a Stratum-1 clock signal from an SoC. In one embodiment, the method includes: (1) receiving a phase-modulated timing signal from WWVB into a time code receiver clock source supported by a monolithic substrate, (2) generating a clock signal for the SoC based on the phase-modulated timing signal and (3) employing the phase-modulated timing signal in at least one of a processor, memory and other SoC circuitry supported by the monolithic substrate.

Yet another aspect provides a device. In one embodiment, the device includes: (1) an SoC, having: (1a) a monolithic substrate, (1b) a time code receiver clock source supported by the monolithic substrate and configured to receive a timing signal and generate a clock signal for the SoC and (1c) at least one of a processor, memory and other SoC circuitry supported by the monolithic substrate and configured to receive the clock signal from the time code receiver clock source, (2) a user interface, (3) other device hardware, firmware or software and (4) a bus coupling the SoC, the user interface and the other device hardware, firmware or software.

### BRIEF DESCRIPTION

Reference is now made to the following descriptions taken in conjunction with the accompanying drawings, in which:

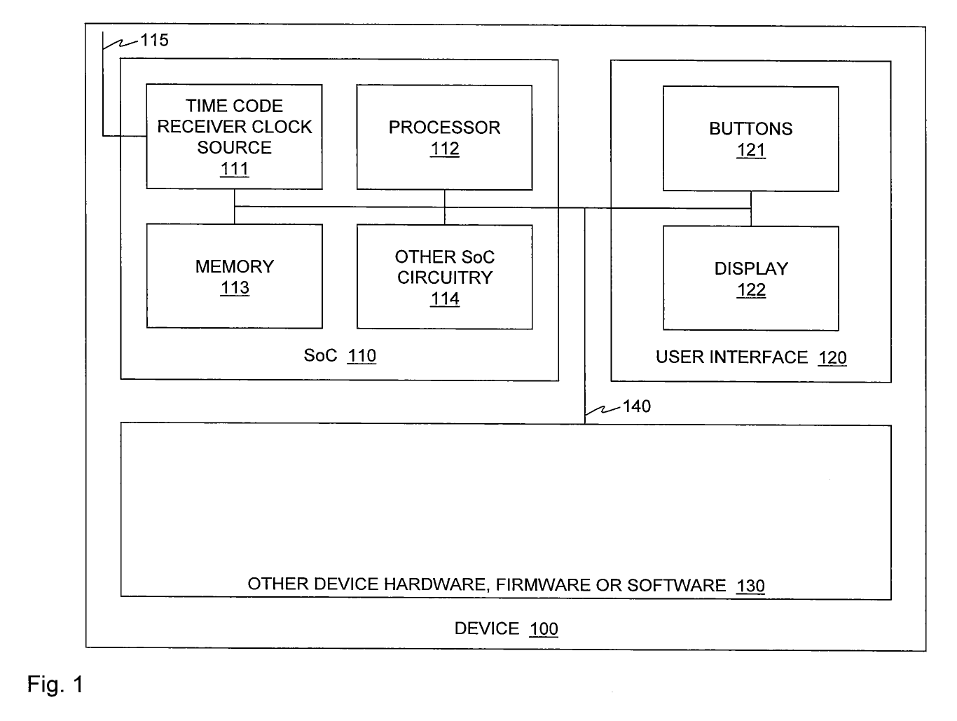

FIG. 1 is a block diagram of one embodiment of a device containing an SoC having an on-chip time code receiver clock source; and

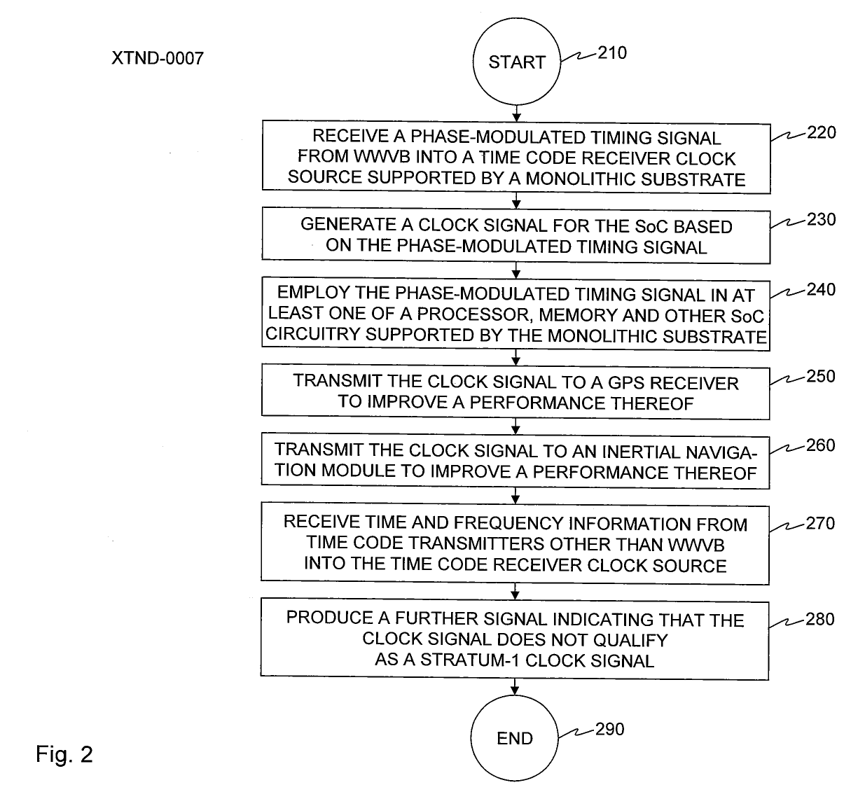

FIG. 2 is a flow diagram of one embodiment of a method of serving a clock signal from an SoC having an on-chip time code receiver clock source.

### DETAILED DESCRIPTION

NIST's low frequency radio station, WWVB, is currently being upgraded to overlay phase modulation on its amplitude modulation. The resulting NIST timing signal has a significantly improved time accuracy, allowing receivers of the WWVB signal to meet the ±1 μs industrial time accuracy requirement, in addition to the frequency requirement.

It is recognized herein that, because the revised NIST timing signal employs phase modulation, a time code receiver clock source can be constructed using far smaller components than are required to receive and decode an amplitude-modulated signal at the 60 kHz transmission frequency. In fact, it is recognized that a time code receiver clock source can be significantly miniaturized. It is further recognized that a time code receiver clock source can be constructed as an IC on a monolithic substrate. It is still further recognized that a time code receiver clock source can be integrated with other circuitry as part of an SoC. The resulting SoC would typically be small and inexpensive and therefore able to be included in a host of devices that have never before benefited from the availability of an internal time code receiver clock source SoC.

Accordingly, described herein are various embodiments of an SoC IC having an on-chip time code receiver clock source and a method of serving a clock signal from an SoC. In addition to receiving the NIST time signal, certain of the embodiments are also configured to receive time and frequency information from other time code transmitters (e.g., JJY in Japan, DCF77 in Germany and GBZ in Great Britain), which are currently less precise. Therefore, the certain embodiments are configured to act as a clock source that is less accurate than a time code receiver clock source in the absence of a suitable timing signal.

According to the various embodiments illustrated and described herein, a new block, a time code receiver clock source, is added to an SoC. Through the addition of this new block, the suitably precise time from a remote atomic clock is now made available to the other blocks on the SoC and can improve the function of these blocks. The precise time also enables functions to be added to the SoC that were impractical or would not have made sense to implement in the absence of a time code receiver clock source.

FIG. 1 is a block diagram of one embodiment of a device 100 containing an SoC 110 having an on-chip time code receiver clock source 111. The SoC 110 has a monolithic substrate (not shown) that is formed of silicon or any other conventional or later-developed material. The SoC 110 may be fabricated by any conventional process and include bipolar transistors or field-effect transistors (FETs), including metal-oxide semiconductor FETs (MOSFETs) and complementary MOS (CMOS) semiconductors. The SoC 110 may also be fabricated by any conventional or later-developed semiconductor fabrication processes and integration scale or “technology.” The time code receiver clock source 111 is configured to receive a timing signal and function as the source of a clock signal for the SoC 110 and, by extension, the device 100 as a whole.

The illustrated embodiment of the SoC 110 further includes a processor 112. In more specific embodiments, the processor 112 may be a microprocessor, a microcontroller and a digital signal processor (DSP). The illustrated embodiment of the SoC 110 further includes memory 113. In more. specific embodiments, the memory 113 may include volatile memory such as dynamic random access memory (DRAM), static random access memory (SRAM) and non-volatile memory, such as read-only memory (ROM) and programmable ROM (PROM), often known as flash memory. The illustrated embodiment of the SoC 110 further includes other SoC circuitry 114. In more specific embodiments, the other SoC circuitry 114 includes custom application-specific IC (ASIC) circuitry for performing functions required in a particular application for the SoC, such as combinatorial logic circuitry and one or more programmable gate arrays (PGAs), a GPS receiver or an inertial navigation module, perhaps including rate and acceleration sensors, for navigation. An antenna 115 is coupled to the time code receiver clock source 111 to facilitate the receipt of time and frequency information.

In addition to the SoC 110, the illustrated embodiment of the device 100 contains a user interface 120 which, in the particular embodiment of FIG. 1, includes one or more user-activatable buttons 121 and a display 122. In various embodiments, the one or more buttons 121 are discrete, hardware buttons or “soft” buttons defined, perhaps intermittently, as areas of a touchscreen display. Accordingly, the display 122 may include a touchscreen display or may be a liquid crystal display (LCD), light-emitting diode (LED) display or one or more indicator lamps of any conventional or later-developed type. Those skilled in the pertinent art will understand that the user interface 120 in general may be of any configuration and combination of conventional or later-developed input or output devices.

In addition to the SoC 110 and the user interface 120, the illustrated embodiment of the device 100 contains other device hardware, firmware or software 130, which may be of any conceivable conventional or later-developed type appropriate to the application or purposes of the device 100. As just a few examples, the other device hardware, firmware or software 130 may include: automotive hardware, home appliance hardware, firmware or software; business machine hardware, firmware or software; telecommunications hardware, firmware or software; timepiece hardware, firmware or software; media (audio or video) processing hardware, firmware or software; industrial control hardware, firmware or software; computer hardware, firmware or software; toy hardware, firmware or software; tool hardware, firmware or software or medical device hardware, firmware or software. Those skilled in the pertinent art will understand that the other device hardware, firmware or software 130 in general may be of any configuration and combination of conventional or later-developed hardware, firmware or software. Finally, a bus 140 couples the SoC 110, the user interface 120 and the other device hardware, firmware or software 130 together, allowing them to communicate and cooperate.

As stated above, the illustrated embodiment of the time code receiver clock source 111 is configured to receive a timing signal and generate a clock signal for the SoC 110 and, by extension, the device 100 as a whole. Various embodiments of the time code receiver clock source 111 are illustrated, described and claimed in the above-referenced co-pending and commonly owned patent application. From the descriptions of these embodiments, it is apparent that the time code receiver clock source 111 is compatible with the remainder of the SoC 110 in terms of fabrication scale, processes and technology, clock signal provision and power requirements. In the illustrated embodiment, the time code receiver clock source 111, as well as the entire SoC 110, is embodied in submicron CMOS and consumes a small percentage of the die area, power and other resources of the SoC 110 as a whole. In the illustrated embodiment, the time code receiver clock source 111 is embodied as a combination of hardware and software. In an alternative embodiment, the time code receiver clock source 111 is embodied in hardware only.

In another alternative embodiment, the time code receiver clock source 111 is embodied in software only. In a more specific embodiment, the time code receiver clock source 111 is active only a relatively small fraction of time (i.e., has a relatively low duty cycle) and therefore execute concurrently in a processor (e.g., the processor 112) with other software.

In the illustrated embodiment, the time code receiver clock source 111 is a standalone block (sometimes referred to as a “cell” or a “module”) having its own, dedicated logic elements or resources. In an alternative embodiment, the time code receiver clock source 111 makes at least some use of existing resources of the SoC 110. In another alternative embodiment, the time code receiver clock source 111 embodies functions other than a time code receiver clock source. For example, in a specific embodiment, the time code receiver clock source 111 embodies an amplitude modulation (AM) radio receiver. In another specific embodiment, the time code receiver clock source 111 embodies a low-frequency radio receiver configured to operate on an alternative modulation scheme, such as frequency modulation (FM) or pulse code modulation (PCM).

In one embodiment, the other SoC circuitry 114 includes a GPS receiver (not shown). In this embodiment, the time code receiver clock source 111 is configured to transmit clock signals to the GPS receiver to improve its performance, e.g., its time-to-first-fix or reception with fewer satellites. In a related embodiment, the time code receiver clock source 111 is configured to provide a backup to any GPS time signal provided by the GPS receiver when the GPS time signal is unavailable. In another related embodiment, the GPS time signal can provide a backup to the clock signal provided by the time code receiver clock source 111 when the clock signal provided by the time code receiver clock source 111 is unavailable.

In another embodiment, the other SoC circuitry 114 includes an inertial navigation module, perhaps including rate and acceleration sensors, for navigation. In this embodiment, the time code receiver clock source 111 is configured to transmit clock signals to the module to improve navigation and positioning performance of the module and, by extension, the device 100.

In yet another embodiment, the time code receiver clock source 111 is configured to adjust other oscillators or clocks that exist in the SoC 110 or in the device 100 as a whole. As those skilled in the pertinent art understand, occasional, perhaps periodic, adjustment of these oscillators or clocks based on the received phase-modulated NIST timing signal enables improved performance, the same performance with and less accurate and expensive crystal and oscillator components. For example, a function that ordinarily requires a ±20 parts-per-million (ppm) oscillator may be able to employ a ±100 ppm oscillator instead. For another example, a function that ordinarily requires a temperature-controlled oscillator may be able to employ a non-temperature-controlled oscillator instead. In both examples, the time code receiver clock source 111 is configured to adjust the less-accurate oscillators to improve their performance to at least acceptable levels.

In still another embodiment, the time code receiver clock source 111 is configured to provide a timestamp traceable to certified or authenticated (e.g., government) clock sources. As a result, the SoC 110 is configured for operation in applications requiring such timestamp. In a more specific embodiment, the timestamp provided by the time code receiver clock source 111 is employed to verify hardware modules in the device 100 as secure and trusted to combat fraud and hacking.

In yet still another embodiment, the time code receiver clock source 111 is configured to receive time and frequency information from time code transmitters other than WWVB. If the one of the other time code transmitters from which the time code receiver clock source 111 is receiving time and frequency information is less precise than the phase-modulated time signal from WWVB, the output of the time code receiver clock source 111 will not meet either or both of Stratum-1 qualifications. In such event, one embodiment of the time code receiver clock source 111 is configured to produce a clock signal that does not qualify as a Stratum-1 clock signal. Therefore, the certain embodiments are configured to act as a clock source that is less accurate than a time code receiver clock source in the absence of a suitable time and frequency information. In a complementary embodiment, the time code receiver clock source 111 is configured to produce a further signal indicating that the clock signal being produced does not qualify as a Stratum-1 clock signal.

In various other embodiments, the time code receiver clock source 111 is configured to support novel built-in-self-test (BIST) and diagnostic features and real-time monitoring of other resources of the SoC 110, including resources that create or use time. In more specific embodiments, the BIST features include precise measurement of device direct current (DC)-parameters, such as capacitance, resistance and inductance, and alternating current (AC)-parameters, such as transistor switching speed. Device testers are conventionally required to provide accurate timing references to measure such parameters. However, device testers are rarely available where an SoC may be deployed. In another embodiment, trends in frequency and time accuracy can be tracked, allowing early failure warning and detection information to be provided to prompt repair and avoid subsequent, perhaps critical, failures.

FIG. 2 is a flow diagram of one embodiment of a method of serving a clock signal from an SoC having an on-chip time code receiver clock source. The method begins in a start step 210. In a step 220, a phase-modulated timing signal is received from WWVB into a time code receiver clock source supported by a monolithic substrate. In a step 230, a clock signal is generated for the SoC based on the phase-modulated timing signal. In a step 240, the phase-modulated timing signal is employed in at least one of a processor, memory and other SoC circuitry supported by the monolithic substrate. In a step 250, the clock signal is transmitted to a GPS receiver to improve a performance thereof. In a step 260, the clock signal is transmitted to an inertial navigation module to improve a performance thereof. In a step 270, time and frequency information is received from time code transmitters other than WWVB into the time code receiver clock source. In a step 280, the time code receiver clock source then produces a further signal indicating that the clock signal does not qualify as a Stratum-1 clock signal. The method ends in an end step 290.

Those skilled in the art to which this application relates will appreciate that other and further additions, deletions, substitutions and modifications may be made to the described embodiments.

What is claimed is:

1. A system-on-a-chip (SoC), comprising:
a monolithic substrate;
a time code receiver clock source supported by said monolithic substrate and configured to receive a timing signal and generate a clock signal for said SoC; and
at least one of a processor, memory and other SoC circuitry supported by said monolithic substrate and configured to receive said clock signal from said time code receiver clock source.

2. The SoC as recited in claim 1 wherein a semiconductor fabrication and integration scale and technology of said time code receiver clock source is identical to said at least one of said processor, memory and other SoC circuitry.

3. The SoC as recited in claim 1 wherein said time code receiver clock source is configured to make at least some use of said at least one of said processor, memory and other SoC circuitry.

4. The SoC as recited in claim 1 wherein said time code receiver clock source is configured to embody functions other than a time code receiver clock source.

5. The SoC as recited in claim 1 wherein said time code receiver clock source is configured to transmit said clock signal to a GPS receiver to improve a performance thereof.

6. The SoC as recited in claim 1 wherein said time code receiver clock source is configured to transmit said clock signal to an inertial navigation module to improve a performance thereof.

7. The SoC as recited in claim 1 wherein said time code receiver clock source is configured to adjust other oscillators or clocks in said SoC.

8. The SoC as recited in claim 1 wherein said time code receiver clock source is configured to receive time and frequency information from time code transmitters other than WWVB and produce a further signal indicating that said clock signal does not qualify as a Stratum-1 clock signal.

9. A method of serving a Stratum-1 clock signal from a system-on-a-chip (SoC), comprising:
receiving a phase-modulated timing signal from WWVB into a time code receiver clock source supported by a monolithic substrate;
generating a clock signal for said SoC based on said phase-modulated timing signal; and
employing said phase-modulated timing signal in at least one of a processor, memory and other SoC circuitry supported by said monolithic substrate.

10. The method as recited in claim 9 wherein said time code receiver clock source makes at least some use of said at least one of said processor, memory and other SoC circuitry.

11. The method as recited in claim 9 further comprising transmitting said clock signal to a GPS receiver to improve a performance thereof.

12. The method as recited in claim 9 further comprising transmitting said clock signal to an inertial navigation module to improve a performance thereof.

13. The method as recited in claim 9 further comprising employing said clock signal to adjust other oscillators or clocks in said SoC.

14. The method as recited in claim 9 further comprising:
receiving time and frequency information from time code transmitters other than WWVB into said time code receiver clock source; and
producing a further signal indicating that said clock signal does not qualify as a Stratum-1 clock signal.

15. A device, comprising:
an SoC, including:
a monolithic substrate,
a time code receiver clock source supported by said monolithic substrate and configured to receive a timing signal and generate a clock signal for said SoC, and
at least one of a processor, memory and other SoC circuitry supported by said monolithic substrate and configured to receive said clock signal from said time code receiver clock source;
a user interface;
other device hardware, firmware or software; and
a bus coupling said SoC, said user interface and said other device hardware, firmware or software.

16. The device as recited in claim 15 wherein a semiconductor fabrication and integration scale and technology of said time code receiver clock source is identical to said at least one of said processor, memory and other SoC circuitry.

17. The device as recited in claim 15 wherein said time code receiver clock source is configured to make at least some use of said at least one of said processor, memory and other SoC circuitry.

18. The device as recited in claim 15 wherein said time code receiver clock source is configured to embody functions other than a time code receiver clock source.

19. The device as recited in claim 15 wherein said time code receiver clock source is configured to transmit said clock signal to a GPS receiver to improve a performance thereof.

20. The device as recited in claim 15 wherein said time code receiver clock source is configured to transmit said clock signal to an inertial navigation module to improve a performance thereof.

21. The device as recited in claim 15 wherein said time code receiver clock source is configured to adjust other oscillators or clocks in said device.

22. The device as recited in claim 15 wherein said time code receiver clock source is configured to receive time and frequency information from time code transmitters other than WWVB and produce a further signal indicating that said clock signal does not qualify as a Stratum-1 clock signal.
